(19) United States
(12) Patent Application Publication
(10) Pub. No.: US 2014/0122695 A1
(43) Pub. Date: May 1, 2014

(54) DYNAMIC RESOURCE ALLOCATION FOR NETWORK CONTENT DELIVERY

(71) Applicant: RAWLIN INTERNATIONAL INC., (unknown)

(72) Inventors: Denis Kulikov, Saint-Petersburg (RU); Anton Prokopenko, Saint-Petersburg (RU); Maksim Shakhmetov, Saint-Petersburg (RU); Artem Kirakosyan, Saint-Petersburg (RU)

(73) Assignee: RAWLLIN INTERNATIONAL INC., Tortola (VG)

(21) Appl. No.: 13/665,338

(22) Filed: Oct. 31, 2012

(51) Int. Cl. H04L 12/24

(52) U.S. Cl. CPC H04L 41/00; H04L 43/00
USPC 709/224; 709/226

(57) ABSTRACT

Providing for dynamic allocation of network resources for delivery of network content is described herein. By way of example, network resources can be correlated with real-time network conditions, and monitoring of the network conditions can be employed to track availability of subsets of network resources. Where a subset of network resources allocated to support a particular application is available, the subset of resources can be allocated to one or more client devices, on demand. Where insufficient resource availability exists, resources can be freed up from other subsets of network resources to bolster availability of requested resources to support an application, or a demand for resources can be rejected. Billing for network resources can be in part or in total based on resources consumed, among other dynamic factors, in addition to or in lieu of static factors.

### TECHNICAL FIELD

The subject disclosure relates generally to network content delivery, and more particularly to providing dynamic allocation of network resources for client devices in a network communication environment.

### BACKGROUND

Advancements in high-speed last mile access to the Internet have enabled consumers to greatly expand the scope and diversity of content they can receive through electronic communications. Likewise, advancements in network storage space, such as cloud storage in one example, and multiple access server technology has enabled multimedia service providers to store and distribute larger and more diverse content. Such content can include media, multimedia, text, graphics, and so on. Network-stored media in particular is becoming very popular, ranging from relatively small audio content like songs and ringtones, to larger podcasts, full length movies, and even much larger audio-video content. It is not hyperbole to say, therefore, that fixed electronic communication systems have become a backbone of industrial, commercial and personal communications worldwide. Likewise, mobile communication networks have provided voice and data communication functionality that have become near-ubiquitous for both business and personal communications throughout much of the world. Content-related communication, for audio/video entertainment, single player and multiplayer online games, and the like, has also become popular, utilizing the fundamental architecture of the Internet and associated webs or networks as the underlying data/content communication platform.

Content and service providers generally employ multi-access servers to handle client communication or content requests, provide encryption or other security, and to track usage for billing content and services consumed by client devices. For high data applications and related content archiving, large capacity data storage devices are often utilized and configured to store this content, and in conjunction with the multi-access servers, permit access to subsets of the stored content. Common modern examples of online content or services include multimedia content such as movies, episode-based television content such as sitcoms, news programs, and other audio/video content, as well as audio content, and even real time interactive audio/video content, single-player or multiplayer games, as well as communication services, blogs, online forums, e-mail, text messaging, multimedia messaging, and so on.

A popular interface between the service provider and the consumer is a subscriber account. A consumer provides identification information and establishes login credentials for purposes of identifying themselves and restricting access to the subscriber account. Upon authorizing access to a subscriber account, selected content or services requested via a client device logged in to the subscriber account can be delivered over a network for consumption. This framework enables content providers to track the usage of a particular subscriber, to facilitate billing the account for content and services consumed via the account.

In addition, the subscriber account can store information or choices about content services, content delivery services or the content itself, client device information, and so on, via the subscriber account. Thus, different levels of service can be established for different subscribers, and different billing rates established for different levels of service, all stored at the subscriber account. This enables network content providers to provide a range of billing rates and therefore accommodate a range of costs for a population of consumers. It also enables content providers to distribute specialized services or features for a subset of consumers who are interested in those services or features. Thus, the subscriber account facilitates a great deal of diversity in online content services.

Because network multimedia content is managed via client-server communications over a network, client authorization and user verification procedures are employed to control client access to content. A server might, for instance, be provisioned to check that a client device is associated with a subscription account offered by a particular content provider. This allows a service provider to limit content delivery only to those users who have an agreement with the service provider, as well as protect intellectual property rights of content owners. As technology associated with consumer playback devices and network access infrastructure changes, providers typically adapt their services to achieve new possibilities made available by these technological changes. This evolution in technology is ongoing, and generates seemingly perpetual demand to expand upon or improve existing content or services to match these changes, and is one of many current challenges related to online multimedia content delivery.

### SUMMARY

The following description and the annexed drawings set forth in detail certain illustrative aspects of the disclosed subject matter. These aspects are indicative, however, of but a few of the various ways, or embodiments, in which the principles of the disclosed subject matter may be implemented. The disclosed subject matter is intended to include all such embodiments and their equivalents. Other advantages and distinctive features of the disclosed subject matter will become apparent from the following detailed description of the various embodiments when considered in conjunction with the drawings.

One or more aspects of the subject disclosure provide for dynamic allocation of network resources for delivery of network content. Network resources can include a level of Quality of Service (QoS) for network content, a data protocol or encoding protocol for network transmission, content delivery rate parameters such as a guaranteed bit rate, bandwidth, etc., or the like, or a suitable combination thereof. The network resources can be correlated with real-time network conditions, and monitoring of the network conditions can be employed to track availability of network resources. Where network resources sufficient to support a particular application are available, a subset of resources can be allocated to one or more client devices, on demand. Where insufficient resource availability exists, resources can be freed up (e.g., based on a client priority level), or a demand for resources can be rejected.

In particular aspects of the subject disclosure, real-time network conditions are measured or analyzed and respective values for the network conditions are obtained, which can then be updated to a matrix. Predefined rules can be established for analyzing the matrix and making decisions pertaining to availability of content services, availability of a particular QoS for one or more content services, whether QoS should be increased or decreased to support a particular service, or the like. The matrix can be updated dynamically to capture changes in the real-time network conditions. In addition, the matrix can relate respective content services to subsets of network resources, enabling rapid identification of what resources are required in response to activation of a particular content service at the client device.

In addition to the foregoing, client devices can be configured to monitor resource consumption associated with particular content services. Respective levels of resource consumption at a client device can be uploaded to a network by respective client devices, providing the network with information as to resource consumption as a function of application, or category(ies) of application. Moreover, client devices can notify the network of instances of a particular activation, enabling the network to analyze and determine availability of desired levels of QoS and associated network resources needed to service the particular application.

In particular aspects of the subject disclosure, the matrix can correlate real-time network conditions with qualitative assessments or quantitative valuations for those network conditions, based on network measurement or analysis, client device measurement or analysis, or a combination thereof. Degrees of QoS can be correlated with subsets of the network conditions and predetermined assessments or valuations. When real-time assessments or valuations for a subset of the network conditions meet or exceed predetermined thresholds thereof, a degree of QoS can be met by the network.

In still other aspects of the subject disclosure, degrees of QoS can be alternatively or additionally correlated with a set of client network services. An additional matrix can be generated that provides the correlation of degrees of QoS with the set of client network services. The additional matrix can be populated with information indicating support for respective degrees of QoS based on the real-time network conditions of the above matrix, and the support can be related to availability of respective ones of the set of client network services. In addition, the matrix can identify degrees or levels of support, based on the respective degrees of QoS. When a service is requested by a client device, the additional matrix can be referenced to determine whether a degree of QoS sufficient to support the service, and in some aspects a level of such support (e.g., poor, fair, good, . . . ) for the service. If the degree of QoS is sufficient to support the service at an adequate level of service, network resources can be allocated to the client device as established by the degree of QoS, in response to the degree of QoS being sufficient to support the service. Otherwise, the client can be informed that service is unavailable, or that only best effort service can be provided.

The following description and the annexed drawings set forth in detail certain illustrative aspects of the disclosed subject matter. These aspects are indicative, however, of but a few of the various ways in which the principles of the disclosed subject matter can be employed and the disclosed subject matter is intended to include all such aspects and their equivalents. Other advantages and novel features of the disclosed subject matter will become apparent from the following detailed description when considered in conjunction with the drawings.

### BRIEF DESCRIPTION OF THE DRAWINGS

FIG. 1 illustrates a block diagram of an example system for dynamic allocation of network resources for client services in various aspects of the disclosure.

FIG. 2 depicts a block diagram of a sample system for parsing network conditions to support dynamic allocation of network resources, in particular aspects.

FIG. 3 illustrates a block diagram of an example system for managing network resources to support varying levels of QoS for client devices.

FIG. 4 depicts a diagram of an example matrix for analyzing network conditions with respective to providing correlated network services, according to aspects.

FIG. 5 depicts a diagram of an example correlation between network services and subsets of network resources for supporting those services.

FIG. 6 illustrates a diagram of a sample matrix correlating network conditions with network services and degrees of QoS support for those services.

FIG. 7 illustrates a block diagram of an example electronic device for providing dynamic resource allocation for network content services, in other aspects.

FIG. 8 depicts a flowchart of a sample method for operating a client device to support dynamic resource allocation according to further aspects.

FIGS. 9 and 10 illustrate a flowchart of an example method for providing real-time client conditions and application demand in particular aspects herein.

FIG. 11 illustrates a flowchart of an example method for providing dynamic allocation of QoS to support content services for network client devices.

FIG. 12 depicts a block diagram of an example electronic computing environment that can be implemented in conjunction with one or more aspects.

FIG. 13 depicts a block diagram of an example data communication network that can be operable in conjunction with various aspects described herein.

### DETAILED DESCRIPTION

The disclosed subject matter is described with reference to the drawings, wherein like reference numerals are used to refer to like elements throughout the description. In the following description, for purposes of explanation, numerous specific details are set forth in order to provide a thorough understanding of the subject innovation. It may be evident, however, that the disclosed subject matter may be practiced without these specific details. In other instances, well-known structures and devices are shown in block diagram or schematic form in order to facilitate describing various aspects disclosed herein.

Reference throughout this specification to “one embodiment,” “an embodiment,” “a disclosed aspect,” or “an aspect” means that a particular feature, structure, or characteristic described in connection with the embodiment or aspect is included in at least one embodiment or aspect of the present disclosure. Thus, the appearances of the phrase “in one embodiment,” “in one aspect,” or “in an embodiment,” in various places throughout this specification are not necessarily all referring to the same embodiment. Furthermore, the particular features, structures, or characteristics may be combined in any suitable manner in various disclosed embodiments.

As utilized herein, terms “component,” “system,” “module”, “interface,” “user interface”, and the like are intended to refer to a computer-related entity, hardware, software (e.g., in execution), and/or firmware. For example, a component can be a processor, a process running on a processor, an object, an executable, a program, a storage device, and/or a computer. By way of illustration, an application running on a server and the server can be a component. One or more components can reside within a process, and a component can be localized on one computer and/or distributed between two or more computers.

Further, these components can execute from various computer readable media having various data structures stored thereon. The components can communicate via local and/or remote processes such as in accordance with a signal having one or more data packets (e.g., data from one component interacting with another component in a local system, distributed system, and/or across a network, e.g., the Internet, a local area network, a wide area network, etc. with other systems via the signal).

As another example, a component can be an apparatus with specific functionality provided by mechanical parts operated by electric or electronic circuitry; the electric or electronic circuitry can be operated by a software application or a firmware application executed by one or more processors; the one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components. In an aspect, a component can emulate an electronic component via a virtual machine, e.g., within a cloud computing system.

Since the advent of network-based computer services, challenges involved in delivering network services to a dynamic population of client devices have been a driving motive for the multiple-access server system. Such a system enables a population of client devices to request access to services independent from the server and independent from other client devices. Moreover, the server can allocate resources to facilitate network services for a particular client device independent of other client devices.

Though the basic problem of serving a dynamic population of client devices is well served by the multiple-access server system, many secondary challenges still remain. For instance, maximizing resource utilization for a dynamic population of client devices can be beneficial, yet difficult to achieve in practice. Moreover, serving high densities of client devices while avoiding service degradation can be a particularly challenging problem.

In some aspects of the subject disclosure, monitoring and anticipation of network congestion can be utilized as a source of analysis of client device demand or resource requirements, and a forecasting tool for proactive provision of network resources to meet that demand based on the requirements. Network resources are allocated to client devices in response to activation of an application demanding network content. Further, depending on the network resource needs of the application, differing levels of quality of service (QoS) can be provisioned. As utilized herein, QoS refers to a characterization of network resources provisioned to support a network-supported service. Degrees or levels of QoS refer to different characterizations of the network resources, comprising respective subsets of a set of the network resources. Further, respective levels of QoS can also include one or more target quantities or qualities of one or more of the subsets of the network resources. An example of a target quantity can include a specific bit rate, amount of bandwidth, etc., and an example of a quality of a network resource can include a particular data encoding, a particular transmission protocol, a guarantee of a minimum amount of network resources, or the like.

According to particular aspects disclosed herein, monitoring of network conditions and client device activity can yield respective states of one or more client devices. An inference can be drawn based on client device state as to network resources (e.g., a level of QoS) to be allocated to a particular client device. Further, billing for allocated services can be established in a manner that is dependent upon allocated network resources or network conditions. Thus, for instance, when a client device is consuming a service during a low congestion period (e.g., when relatively few client devices are consuming resources, when relatively few network resources are currently allocated, . . . ), a usage tariff can be set to a lower rate. Likewise, when the client device is consuming network resources at peak times, during relatively high congestion, or the like, a premium tariff can be imposed on network resources allocated to the client device. As another example, where a network resource is utilized that involves a high level of QoS or otherwise demands high resources (e.g., high definition video conferencing with multiple participants) a higher rate can be imposed, and so on. To support such an arrangement, a network can be configured to monitor the steady state of client devices and of network conditions and to balance traffic and network resources in real-time to accommodate a maximum number of client devices, or maximum number of network services, given a set of network resources.

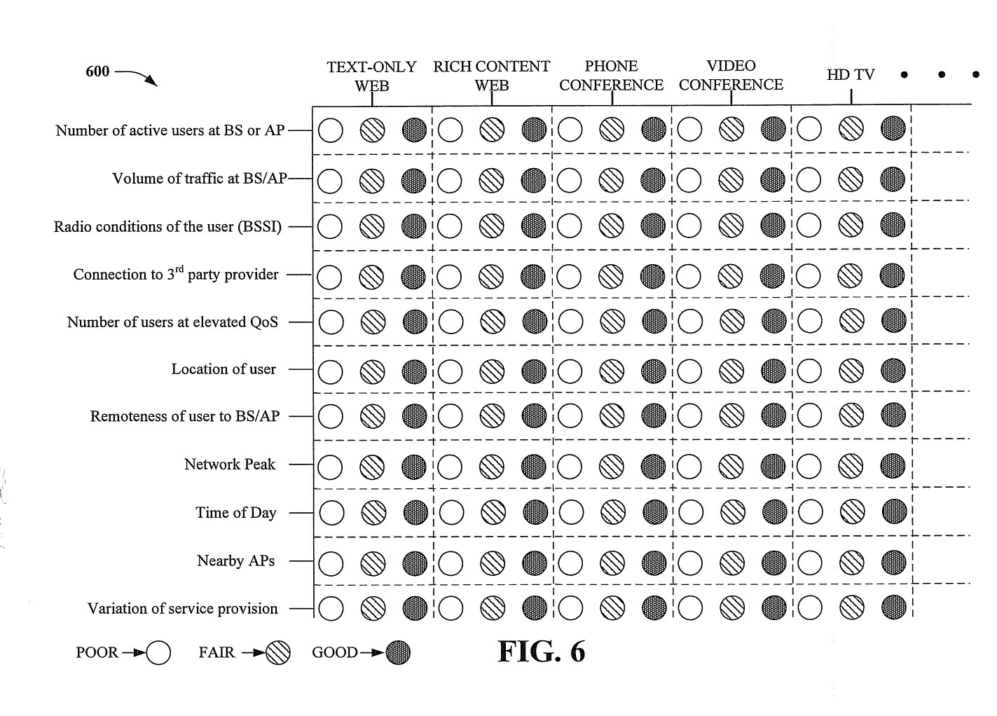

In further disclosed aspects, a network can acquire information pertaining to network conditions and states of client devices. This information can be obtained from reporting performed by client devices, as well as monitoring components of the network. Acquired information can then be evaluated qualitatively or quantitatively, and updated to a network matrix. The network matrix can correlate real-time network conditions with level of QoS identifiers (IDs), also referred to herein as service IDs. The matrix can be populated with the qualitative or quantitative evaluations of respective network conditions, in a manner that indicates support, or degree of support, for respective service IDs. Degree of support can include various suitable ranges, whether quantitative (e.g., a range of one through five, one indicating lowest support and five indicating highest support) or qualitative (e.g., poor, fair, good, . . . ), or a suitable combination thereof. In at least some aspects of the subject disclosure, an additional matrix can be generated that correlates respective service IDs with respective network services. The additional matrix can be populated with an evaluation indicating suitability of available network resources associated with respective service IDs for supporting the respective network services (e.g., see FIG. 6, infra). Thus, by referencing this additional matrix, the network can readily determine what service ID is associated with a particular requested network service, and whether sufficient network resources are available to provide the level of QoS associated with the service ID. Moreover, these matrices can be updated dynamically with information indicating a change in state of client devices or network conditions. Accordingly, by updating the matrices a steady-state indication of available resources relative to demand for such resources can be referenced to balance network resources among a dynamic population of client devices.

In at least one additional aspect of the subject disclosure, network resources associated with particular levels of QoS can be modified to further accommodate client demand. For instance, where a particular network resource utilized to provide a network service(s) is near capacity, another network resource(s) can be allocated to a service ID associated with that network service, where suitable. As one example, where bandwidth at a particular network access point serving a subset of client devices for the network is nearing capacity, one or more other suitable network access points can be reconfigured to provide additional bandwidth to the access point that is near its bandwidth capacity. As another example, a level of QoS for one or more of the subset of client devices can be lowered temporarily to free up network resources for additional client devices. Where location of client devices is obtained and is indicative of a network access point to which respective client devices may connect to the network (e.g., as in a mobile communication network), such location can be utilized to anticipate higher capacities at one or more network access points. In response, the network can attempt to allocate additional resources to the one or more network access points to serve the anticipated higher capacity of client devices.

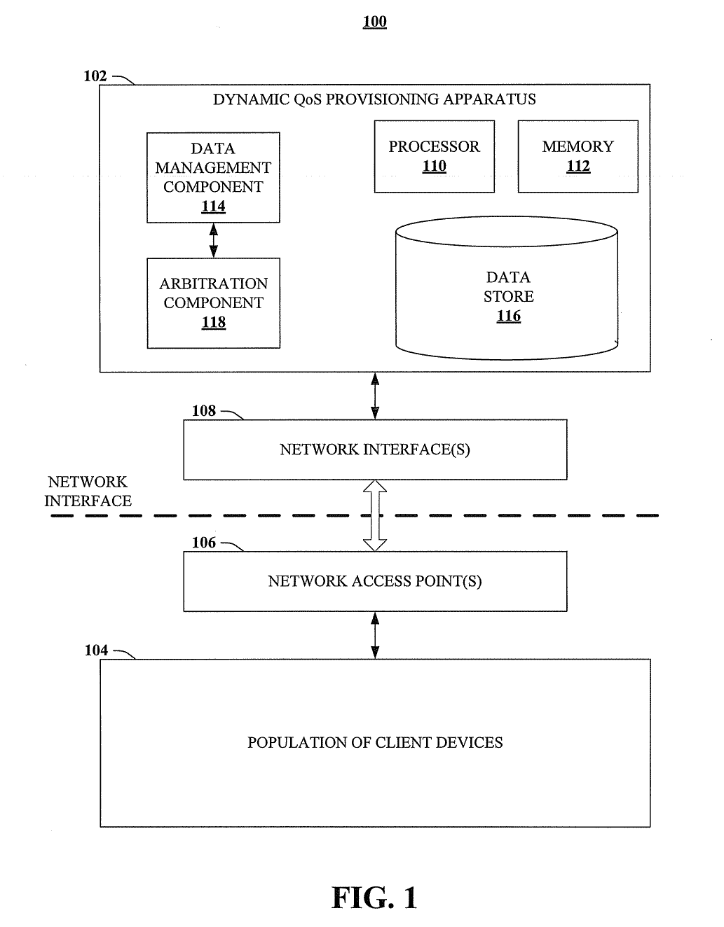

FIG. 1 illustrates a block diagram of an example system 100 configured for dynamic provisioning of network resources for client devices, according to various aspects of the subject disclosure. System 100 can comprise a dynamic QoS provisioning apparatus 102 that is communicatively connected to one or more network interfaces 108 for communicating with a service network. A service network can comprise an Internet service provider, mobile phone service provider, an intranet, and so on, and can also include content provisioning systems or networks connected directly with the service network, or communicatively connected with the service network through one or more network gateways. Network interfaces 108 can include the network gateways, but can also include data communication systems within the service network (e.g., routers, internal gateways, domain name servers, and so on). Network interfaces 108 are communicatively connected to one or more network access points 106 employed by a population of client devices 104 for obtaining access to the service network. Network access points 106 can include wireless access points (e.g., Wi-Fi access points, a base station(s) of a terrestrial radio access network, a WiMAX base station) as well as wired access points (e.g., an Internet service provider access point, such as a digital subscriber line access multiplexer [DSLAM] utilized for a digital subscriber line [DSL] Internet service, a cable modem termination system in a cable Internet service, analogous equipment for a fiber edge-network system, and so on). Note that although network access points 106 are depicted as being on a client side of client-network interactions of system 100, it should be appreciated that some or all network access points 106 can be at a network side of client-network interactions instead.

Dynamic QoS provisioning apparatus 102 can be configured for obtaining, analyzing and utilizing real-time network conditions for allocating network resources to service client devices 104. As depicted, dynamic QoS provisioning apparatus 102 can comprise a memory 112 for storing instructions, rules, protocols, or the like, for operating dynamic QoS provisioning apparatus 102, and components thereof. In addition, dynamic QoS provisioning apparatus 102 can comprise a processor(s) 110 for executing these instructions, rules, protocols, etc., to implement the operations of dynamic QoS provisioning apparatus 102.

Dynamic QoS provisioning apparatus 102 can employ network interface(s) 108 to dynamically acquire respective communication-related conditions for population of client devices 104. These communication-related conditions can comprise, as general examples, network resource demands of client devices 104, network resource availability, current resource allocation levels, capacity for resource re-organization to serve clusters of client devices, or the like. More particular examples of communication-related conditions can include number of active client devices at an access point (e.g., number of mobile phones at a base station, . . . ), volume of traffic at an access point, respective or aggregate connectivity metrics of client devices 104 (e.g., bandwidth, data rates, jitter, noise, SNR, cross-talk, scattering, signal strength, . . . ), connectivity of a third party service provider with a service network associated with system 100 (e.g., connectivity of a third-party e-mail service and the service network, where the third-party e-mail service utilizes the service network as a communication intermediary for providing e-mail communications to client devices 104), number of client devices 104 allocated to higher levels of QoS (e.g., allocation of a greater amount of network resources, a stronger guarantee of network resources, . . . ), location or remoteness of client devices from access points, network peak or non-peak time, historical usage patterns (e.g., time-of-day based resource usage, event-based resource usage, seasonal-based resource usage, . . . ), availability of alternate access points for one or more of client devices 104, QoS requirements of subscription plans associated with client devices 104, or like examples, or suitable combinations thereof.

Communication-related conditions acquired by dynamic QoS provisioning apparatus 102 can be stored in a data store 116. Particularly, data store 116 can be configured for storing a matrix that relates a set of conditions (e.g., the communication-related conditions) with information related to provisioning of network services to client devices 104. Moreover, dynamic QoS provisioning apparatus 102 can comprise a data management component 114 configured to update changes in the set of conditions to the matrix stored in data store 116. New information related to the set of conditions can be received at data management component 114, whether uploaded from client devices 104 themselves, or collected by monitoring equipment (not depicted) of the service network. Thus, as changes in the communication-related conditions are obtained by dynamic QoS provisioning apparatus 102, the matrix within data store 116 can be updated to reflect the new information, which in turn can be utilized for controlling the provisioning of network services by the matrix.

Dynamic QoS provisioning apparatus 102 can further comprise an arbitration component 118. Arbitration component 118 can be configured for receiving or obtaining a reference to network service demands of client devices 104. For instance, when a network service is initiated at one of client devices 104 (e.g., an application requiring content from the service network, . . . ), arbitration component 118 can be configured for identifying a subset of network resources that matches the network service. The subset of network resources can be a predetermined set of network resources assigned to the network service, a set of network resources that is partially predetermined and partially dynamically determined, or a set of network resources that is dynamically determined and not predetermined. Arbitration component 118 can reference information stored in data store 116 and determine whether sufficient network resources are available to support the network service. Once a suitable subset of network resources is identified, arbitration component 118 can be configured for allocating the subset of network resources to the one of the client devices.

In particular aspects of the subject disclosure, allocating the subset of network resources can be in response to satisfaction of a qualification criterion. In at least one aspect, the qualification criterion can relate to a current availability of the subset of network resources. In another aspect, the qualification criterion can further relate to a degree of QoS associated with the network service, and whether the current availability of the subset of network resources supports the degree of QoS. In yet other aspects, the qualification criterion can relate to a degree of QoS provided with a service agreement, subscription account, or the like, associated with the client device 104, and whether the current availability supports the degree of QoS. In response to determining the qualification criterion is satisfied, arbitration component 118 can allocate the subset of network resources to the client device 104. In response to determining the qualification criterion is not satisfied, a notice of insufficient resources can be sent in response to the client device 104, or in at least one aspect, a re-balancing of network resources can be attempted to free up resources from one or more other subsets of the network resources, to bolster the subset of network resources matching the network service.

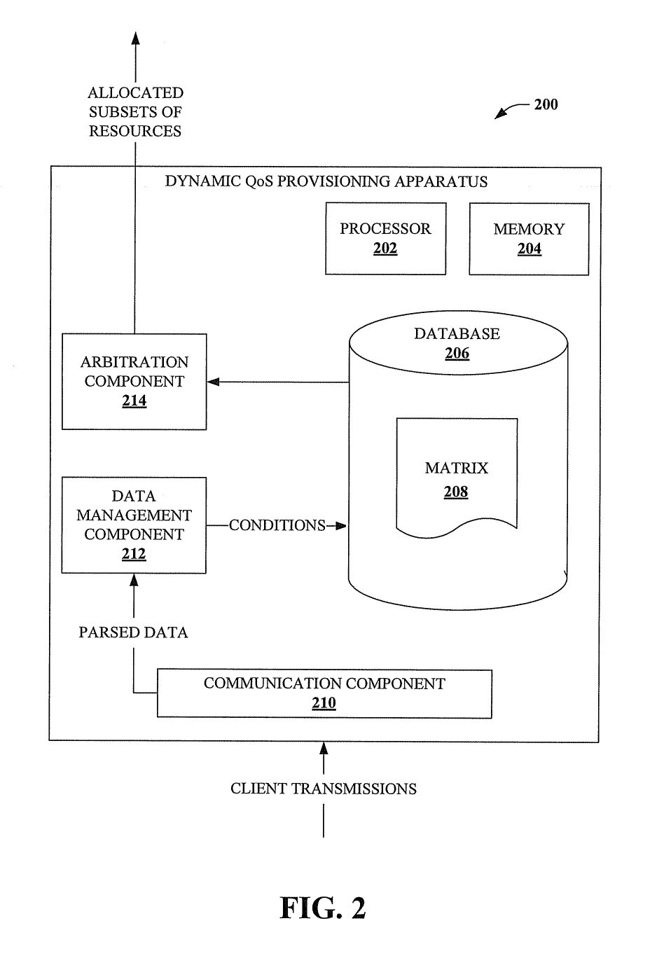

FIG. 2 depicts a block diagram of a sample dynamic QoS provisioning apparatus 200 according to still other aspects of the subject disclosure. Dynamic QoS provisioning apparatus 200 can be configured for dynamically managing network resources based on steady-state conditions of components of a service network, and client devices served by the service network. Particularly, dynamic QoS provisioning apparatus 200 can be configured for parsing data indicative of various network conditions to provide a dynamic representation of a network, for maximizing allocation of network resources for a dynamic population of client devices of the network.

Dynamic QoS provisioning apparatus 200 can comprise a memory 204 for storing instructions pertaining to operating dynamic QoS provisioning apparatus 200, and a processor 202 for implementing the stored instructions. A database 206 can be employed for generating and storing a matrix 208 that associates parsed information indicative of steady-state conditions of the service network, with network resource service identifiers (service IDs). The network resource service IDs can in turn be correlated with respective subsets of network resources, which can be configured, in some aspects of the subject disclosure, to support particular network services (e.g., e-mail, text messaging, Voice over Internet Protocol [VoIP], . . . ). Accordingly, these correlations can be employed to correlate steady-state network conditions with real-time availability of network services.

Dynamic QoS provisioning apparatus 200 can comprise a communication component 210 configured to dynamically acquire respective communication-related conditions for a dynamic population of client devices. Particularly, the communication-related conditions can include dynamic network resource demands of the client devices, steady-state conditions of network equipment or network resources provided by the network equipment, or the like. For instance, communication component 210 can acquire real-time signaling from one or more of the client devices, and extract data pertinent to communication-related conditions or network resource demands pertaining to the client device(s) from the real-time signaling. A data management component 212 can update the communication-related conditions to matrix 208 maintained by database 206. In some aspects, communication component 210 can acquire quantitative values corresponding to one or more measurements pertinent to the communication-related condition(s), which can be updated to the matrix by data management component 212 to reflect the quantitative values. As another example, data management component 212 can be configured to convert the quantitative value into a qualitative assessment of communication-related conditions, and update a segment of the matrix associated with one or more such conditions with the qualitative assessment. Such qualitative assessment can indicate, for instance, poor, adequate or good conditions for one or more network services, or the like. Based on the steady-state conditions of the service network or communication-related conditions of the client devices, an arbitration component 214 can allocate subsets of network resources to service demands of client devices, and output the allocated subsets of network resources from dynamic QoS provisioning apparatus 200.

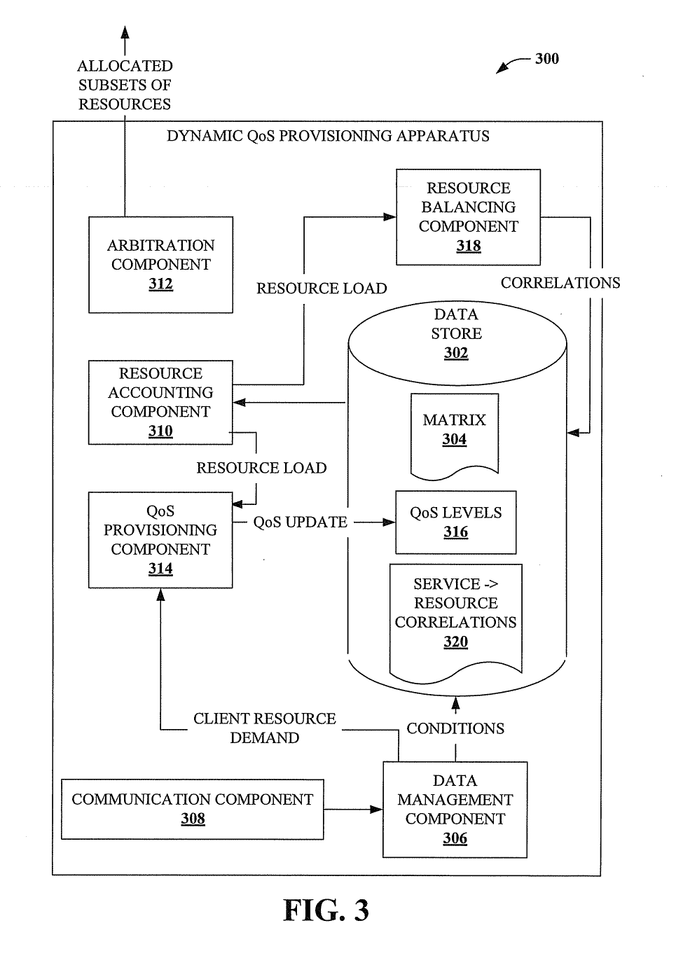

FIG. 3 depicts a block diagram of an example dynamic QoS provisioning apparatus 300 according to still further aspects of the subject disclosure. Dynamic QoS provisioning apparatus 300 can be configured for acquiring and maintaining steady-state information pertaining to network conditions and communication-related conditions of client devices served by a service network associated with dynamic QoS provisioning apparatus 300. Moreover, dynamic QoS provisioning apparatus 300 can allocate network resources to meet service demands of the client devices, and moreover can be configured to dynamically coordinate network resources to meet changing service demands of the client devices.

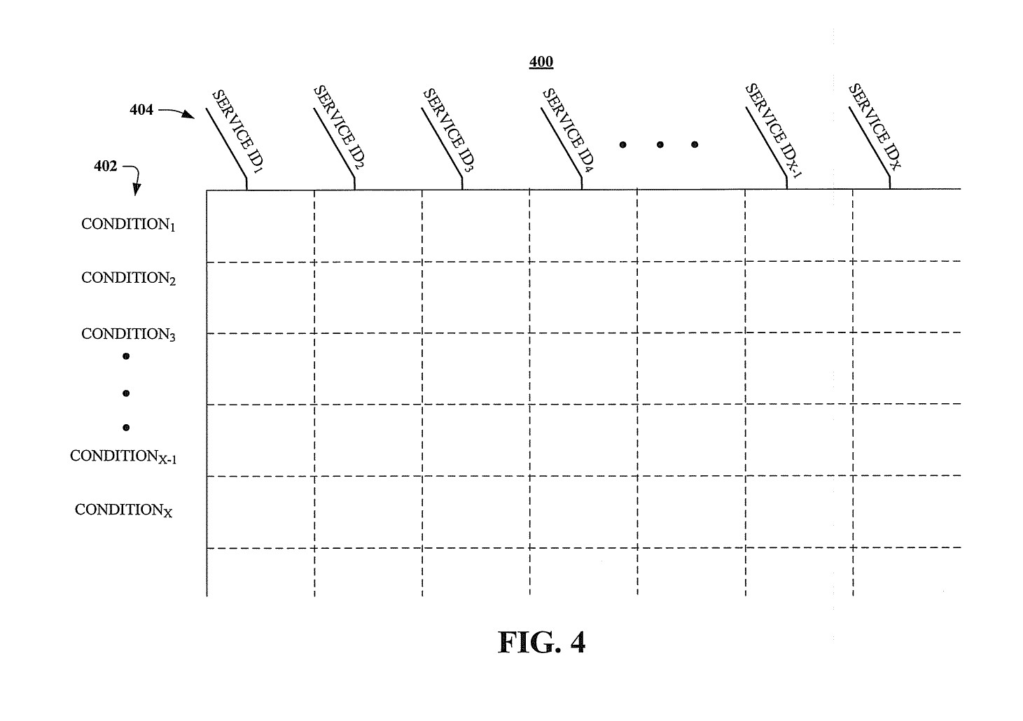

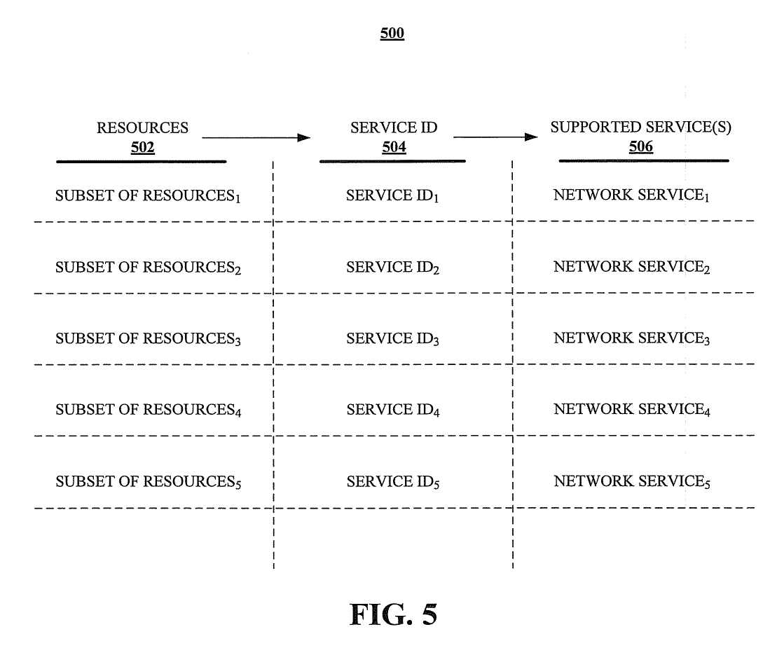

Dynamic QoS provisioning apparatus 300 can comprise a data store 302 that stores one or more matrices 304 of network conditions and network resource service IDs (e.g., see FIGS. 4 and 5, infra). The network resource service IDs can be further related to network services provided by the service network (e.g., see FIGS. 5 and 6, infra). The network resource service IDs can specify particular subsets of network resources to be allocated to client devices in support of predetermined client device applications, or categories of applications. In some aspects, dynamic QoS provisioning apparatus 300 can be configured to dynamically re-define the subsets of network resources supporting particular applications or categories of applications, based at least in part on existing demand for particular network services. For instance, where demand for a particular network service or service ID increases over historical norms, network resources associated with other network services or service IDs can be re-allocated to the particular network service or service ID, as is described in more detail below.

Dynamic QoS provisioning apparatus 300 can comprise a data management component 306 for parsing communication-related conditions reported by client devices to a communication component 308, or network resource consumption reported by network monitoring equipment (not depicted), and updating parsed conditions to matrices 304. A resource accounting component 310 can monitor information quantitative or qualitative valuations of network and communication conditions stored at matrices 304 and determine current availability of respective subsets of network resources. Consumption of network resources, also referred to as resource loading, can be compiled by resource accounting component 310. Where resource loading for a particular service exceeds a threshold consumption level, an arbitration component 312 can be configured to reject allocation of a subset of network resources allocated to the particular service. For instance, arbitration component 312 can output a message indicating unavailability of the particular service in response to a client device requesting the particular service, and in response to resource accounting component 310 determining that the subset of network resources is not available to support the particular service.

In at least one aspect of the subject disclosure, dynamic QoS provisioning apparatus 300 can be configured to re-allocate resources to a particular subset of network resources when the particular subset of network resources exceeds a threshold consumption level. In this aspect(s), resource accounting component 310 can provide a resource load (e.g., percentage of resource consumption) to a QoS provisioning component 314 and a resource balancing component 318. Resource balancing component 318 can be configured to re-allocate a portion of one or more subsets of network resources that are operating under a threshold consumption level to the particular subset of network resources, thereby increasing the availability of the particular subset of network resources, or increasing support for a network service correlated to the particular subset of network resources. Where resource balancing component 318 can re-allocate network resources to the particular subset of network resources, the re-allocated resources can be updated to data store 302 at a service->resource allocation correlation file 320. If the re-allocated resources bring the particular subset of network resources (or newly allocated resources) below a threshold consumption level particular to a network service, arbitration component 312 can then allocate the particular subset of network resources, including newly allocated resources, to client demand for the particular network service. When client demand for the particular network service drops below a consumption threshold level, resource balancing component 318 can be configured to revert the resource allocations stored in service->resource allocation correlation file 320 to default correlations.

In additional aspects of the subject disclosure, QoS provisioning component 314 can be configured to selectively increase or decrease a level of QoS associated with a particular network service. In conjunction with increasing or decreasing the level of QoS, QoS provisioning component 314 can appropriately modify an amount or a quality of network resources (e.g., guaranteed allocation of resources, best effort allocation of resources, . . . ) associated with the level of QoS, and update the amount of quality of network services to a QoS level file 316 of data store 302. Thus, where low QoS service demand increases, the level of QoS associated with network services can be reduced to free up resources reserved for high QoS applications, to support the increased demand of low QoS services. Likewise, where high QoS service demand increases, the level of QoS associated with network services can be increased to free up resources reserved for low QoS applications, to support the increased demand of high QoS services. Based on the foregoing functionality of dynamic QoS provisioning apparatus 300, network resources can be dynamically restructured in support of varying client device demands to optimize the allocation of network services to meet those varying demands.

FIG. 4 illustrates a diagram of an example matrix 400 correlating network communication conditions 402 with service IDs 404 related to communication-related resources of a service network. Network communication conditions 402 can include real-time availability of network resources and subsets of such resources, including memory resources, processing resources, bandwidth resources, QoS resources, and so on. In addition, network communication conditions 402 can include connectivity metrics for a population of client devices served by the service network, availability of alternate or additional access points to the service network (e.g., alternative/additional Internet service access points, neighboring mobile base stations, etc.), peer-to-peer connectivity of client devices, where applicable, as well as instantiation(s) of network content related applications and corresponding network resource demands thereof, at respective client devices. Thus, the network communication conditions 402 can provide a map of network resources and availability of network resources and subsets thereof, as well as demand and prospective demand (e.g., based on instantiation of network-related applications) of client devices. Furthermore, the network communication conditions 402 are correlated with service IDs 404 to provide indication of support for particular network services and respective groups of network resources supporting those services.

Service IDs 404 can be associated with subsets of network resources. In particular, service IDs 404 can be associated with predetermined subsets of network resources that are adapted to support a particular network service, or class of services. The service IDs 404 can have respective valuations for respective network resources included as part of the service ID. In addition, the respective network resources and valuations can be chosen particularly to provide performance, reliability, quality, or the like, or a suitable combination thereof, for the network service or class of services. Resource valuations can include a quantization of one or more resources (e.g., 800 kb bandwidth, 2 megabyte data rate, . . . ), a qualification of one or more resources (e.g., best effort allocation, guaranteed allocation, interruption-free streaming allocation, multi-access point service allocation, . . . ), or a suitable combination thereof. In addition, this qualification and quantification of network resources can be utilized for usage-based billing services, in which client devices are charged for consumption on a pay-for-usage basis, instead of or in addition to a fixed fee basis. This pay-for-usage basis can be modified for peak and non-peak hours of the day, days of the week, seasonality, holidays, local events, and so on, in addition to the consumption-based usage.

Data fields of matrix 400 can be populated with information indicative of a current state of a network communication condition, as a function of service ID. Thus, where condition) relates to bandwidth at a particular access point, and where available bandwidths reserved for the depicted service IDs 404, including service ID₁, service ID₂, service ID₃, service ID₄, . . . , service ID_{X-1}, service ID_{X} (where X is a suitable positive integer) are 5.5 megabytes, 1.0 megabytes, 500 kilobytes, 500 kilobytes, 8 megabytes and 20 megabytes, matrix 400 can be updated with these quantities in the top row associated with condition₁. Similar quantities or qualitative assessments can be populated into data fields for other conditions 402 and service IDs 404.

In conjunction with matrix 400, rules can be established for dynamic resource provisioning of network resources based on information updated to matrix 400 (e.g., by a dynamic QoS provisioning apparatus 100, 200, 300). The rules can establish quantitative or qualitative thresholds for subsets of conditions 402, for indicating availability of a particular service ID 404. Where real-time data for the subsets of conditions 402 satisfies a condition with respect to the quantitative or qualitative thresholds, the rules can allow allocation of network resources associated with the particular service ID 404 in response to a client device request. Where real-time data for the subsets of conditions 402 satisfies a second condition, the rules can permit tentative allocation of resources. Tentative allocation can be conditional upon higher subscriber account rates, for higher rate services, or upon re-allocation of other subsets of resources to support the particular service ID 404, or the like, or a suitable combination thereof. Where real-time data for the subsets of conditions 402 satisfies a third condition, the rules can require denial of associated resources, unless re-allocation of other subsets of resources are sufficient to negate the third condition. Other examples of rules for allocating network resources can be implemented based on real-time data of matrix 400, as is known in the art or made known to one of skill in the art by way of the context provided herein.

FIG. 5 illustrates a diagram 500 of an example correlation of network resources and network services supported by a service network, according to at least one aspect of the subject disclosure. The correlations of diagram 500 can facilitate dynamic resource provisioning for client devices of the service network. In addition, the network resource correlations can be modified to meet temporal spikes in client demand, according to predetermined rules for dynamic re-allocation of resources. The correlations (and modified correlations) can be utilized to track service usage, and facilitate billing rates based at least in part on resource usage.

As depicted, diagram 500 correlates subsets of a set of network resources 502 with a service ID 504, and respective service IDs 504 with supported services 506 thereof. Subsets of resources 502, including subset of resources₁, subset of resources₂, subset of resouces₃, subset of resources₄ and subset of resources (referred to collectively as subset of resources 502) include a predetermined bundle of network resources, and a quantity or quality for at least one network resource of the group of network resources. Examples of network resources which can be grouped together into one or more of subsets of network resources 502 can include bandwidth(s), bit rate(s), single or multi access point service, peer-to-peer support, processor capacity, memory capacity, a transmission priority metric (e.g., for transmitting along a preferred network path), a routing priority metric (e.g., for determining re-transmission or routing priority, position in a routing queue, . . . ), or the like, or a suitable combination thereof. Respective subsets of resources 502 can further specify a quantity for one or more network resources (e.g., 25 kilobyte bandwidth, multiple-in-multiple-out base station service, high routing priority, and so on), or a quality for one or more of the network resources or associated quantities (e.g., best effort allocation of a quantity of resources, guaranteed allocation of the quantity of resources, . . . ), or a combination thereof.

According to particular aspects of the subject disclosure, subsets of resources 502 can be configured to provide preferred or optimal support for a particular network service(s) (e.g., e-mail service, VoIP service, . . . ), or class(es) of network services (e.g., text-only service, text and graphic service, text and audio service, video service, high definition video service, and so on). Likewise, quantities associated with respective ones of the subset of network resources, or associated network resource qualities can be configured for the particular network service(s) or class(es) of network services. Different configurations of network resources can be assigned to different service IDs 504. Thus, the service IDs 504 can provide a placeholder or identifier for the particular network service(s) or class(es) of network services for which respective subsets of resources 502 are configured to provide preferred or optimal service. Supported services 506 include respective particular services for which subsets of resources 502 are configured, or individual network services that fall into a particular class(es) of services for which subsets of resources 502 are configured.

By organizing network resources and network services as a function of service ID, resources required to support a particular service can readily be identified and their availability monitored. Accordingly, contemporaneous support for a service or class of services can readily be determined. Coupled with information indicative of service demand for client devices, including historical service demand or contemporaneous service demand, metrics of availability can be utilized to initiate re-configuration of subsets of resources 502 when such availability drops below a threshold availability, for instance. In addition, organizing network resources and network services as a function of service ID 504 facilitates billing for network services as a function of resource utilization, in part or in whole, as opposed to flat-rate billing.

FIG. 6 illustrates a diagram of an example matrix 600 correlating communication conditions with classes of network services, according to one or more aspects of the subject disclosure. Matrix 600 also includes fields indicating support for a particular network service or class of services, along the top horizontal axis of matrix 600, as a function of communication condition, along the left-side vertical axis of matrix 600. Although three grades of support are indicated in matrix 600, other grade scales can be utilized instead. Further, it should be realized that the communication conditions and network services or classes of services are exemplary only; other communication conditions or network services known in the art or made known to one of skill in the art by way of the context provided herein are considered within the scope of the subject disclosure.

Communication conditions included within matrix 600 include (from top to bottom) number of active client devices at a base station (BS) or access point (AP), volume of traffic at a BS/AP, radio conditions of a client device (for a wireless end-user connection), network connection to a third-party provider, number of client devices operating at an elevated level of QoS, geographic location of a user, distance between client device and BS/AP, network peak condition, time of day, availability of nearby BS/APs, and variation of service provisions. Network services included within matrix 600 along the horizontal axis are text-only web (Internet), rich content web, phone conferencing, video conferencing, and high definition audio/video (television).

As depicted by matrix 600, each intersection of a communication condition on the vertical axis and a network service on the horizontal axis includes a field of matrix 600. Respective fields include a qualitative indication of support for a particular network service(s). Levels of support include poor (illustrated by an empty circle), fair (illustrated by a diagonally-lined circle) or good (illustrated by a shaded circle). Matrix 600 can be associated with predetermined rules for operating the network services indicated on the horizontal axis, which can specify what levels of support for one or more communication conditions are required to provide different levels of support for respective network services. Examples of the different levels of support can include not currently supported, poor support, fair support, good support, optimal support, or some other suitable discrete scale indicative of contemporaneous support for network services. Further, the rules can establish what conditions at one or more fields of matrix 600 are required to meet a particular level of support. Different levels of support can serve as a basis for whether a service is available or not available for client device utilization, a billing rate for the service, whether resource re-allocation should be initiated to increase support for a service, or the like.

As one illustrative example, the following rules can be utilized to govern availability of a network service, text-only web service. Availability of text-only web can require a connection to a third-party Internet provider (e.g., an Internet gateway) to be fair or better, and in a wireless environment, radio conditions of the client device to be fair or better. Satisfaction of these two requirements could result in availability of the text-only web service. In addition, where radio conditions of the client device fall below the fair level, a re-allocation of radio resources can be triggered to improve radio conditions and satisfy the availability requirements. In addition, an optimal level of support for text-only web service can be achieved in the event of good (e.g., low) volume of traffic at BS/AP, good radio conditions of the client device (in the case of wireless), fair or better connection to third-party provider, and fair or better indication of client devices at an elevated QoS (e.g., moderate or few number of such devices). Upon satisfaction of these conditions, a service network can provide optimal support for the text-only web service, which might include higher guaranteed data rates or bandwidth. In the event optimal text-only web service is available, a separate billing rate can optionally be utilized for the client device(s) selecting the optimal text-only web service.

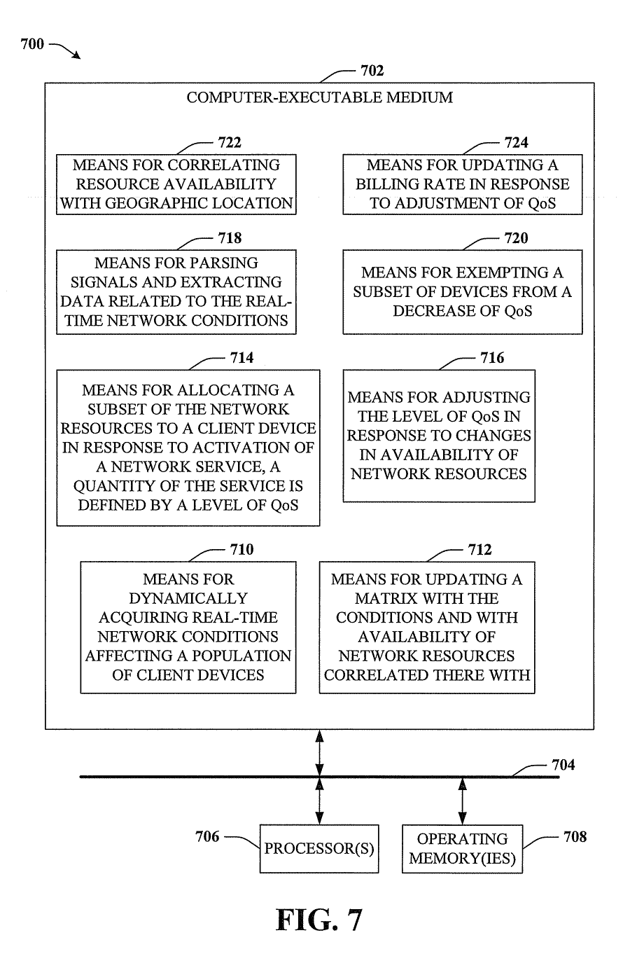

FIG. 7 illustrates a block diagram of an example apparatus 700 for implementing one or more aspects of the subject disclosure. Particularly, apparatus 700 can be configured for providing dynamic resource provisioning to support network services at one or more predetermined qualities of service, to serve dynamic service needs of a population of client devices. For instance, apparatus 700 can reside at least partially within a communication network or within a network server such as a network node, network gateway, terminal device, personal computer coupled with a network interface card, or the like. It is to be appreciated that apparatus 700 is represented as including functional blocks, which can be functional blocks that represent functions implemented by a hardware, software, or combination thereof (e.g., firmware). In some aspects, the functional blocks can represent non-transitory computer-readable media. In other aspects, the functional blocks can represent transitory computer-readable media.

Apparatus 700 can comprise a computer-executable medium 702 comprising one or more computer-executable instructions that can be accessed over a data communication interface 704. Data communication interface 704 can include a communication bus, a media reader (e.g., disc reader, disk reader, driver reader, . . . ), a data ribbon, a wired data interface or data medium, a wireless data interface or data medium, a network communication interface, a network signaling interface, or the like, or a suitable combination thereof. Additionally, the computer-executable instructions can be stored in an operating memory(ies) 708 or executed by a processor(s) 706 to facilitate functionality of apparatus 700.

As depicted, computer-executable medium 702 can include a means 710 for dynamically acquiring real-time network conditions affecting one or more mobile communication devices of a population of mobile communication devices. Additionally, computer-executable medium 702 can include a means 712 for updating a matrix with the real-time network conditions and with availability of network resources that are correlated by the matrix to the real-time network conditions. Further, computer-executable medium 702 can include a means 714 for allocating a subset of the network resources to one of the mobile communication devices in response to activation of a network service related to the subset of the network resources at the one of the mobile communication devices, wherein a quantity of the subset of the network resources is at least in part defined by a level of QoS associated with the network service. In addition to the foregoing, computer-executable medium 702 can include a means 716 for adjusting a level of QoS associated with the network service at least in part in response to changes in the availability of network resources.

In particular aspects of the subject disclosure, computer-executable medium 702 can further include a means 718 for parsing signals transmitted by the population of mobile communication devices and extracting data from the signals related to the real-time network conditions. The means 718 can provide the extracted data to means 712 for updating the extracted data to the matrix.

In further aspects, computer-executable medium 702 can include a means 720 for exempting a subset of the mobile communication devices from a decrease in QoS beyond a baseline level of QoS for network services consumed by the subset of the mobile communication devices. The subset can be established by a special subscription account, a special billing rate, or demands of a particular network service requiring high QoS, or the like, or a suitable combination thereof.

In still other aspects, computer-executable medium 702 can include a means 722 for correlating availability of network resources with geographic locations of a mobile network. Means 722 can provide geographic location correlations to means 716 for adjusting the level of QoS, which in turn can be configured to adjust the level of QoS for subsets of the geographic locations that are associated with elevated consumption of network resources.

According to another aspect, computer-executable medium 702 can include a means 724 for updating a billing rate associated with the network service at least in part in response to adjusting the level of QoS. Although not depicted, in at least one aspect apparatus 700 can further comprise a means for billing a network service that charges an account of the one of the mobile communication devices a rate commensurate with actual resources consumed by the network service, or actual QoS delivered in support of the network service.

The aforementioned diagrams have been described with respect to interaction between several systems, apparatuses, components, user interfaces, and display indicators. It should be appreciated that such diagrams can include those components or systems specified therein, some of the specified components, or additional components. For example, a system could include dynamic QoS provisioning apparatus 300 comprising matrix 400, 500 or 600, and network interface(s) 108 communicatively connected with network access point(s) 106 and population of client devices 104, as one possible example. Sub-components could also be implemented as components electrically connected to other sub-components rather than included within a parent component. Additionally, it should be noted that two or more components could be combined into a single component providing aggregate functionality. For instance, data management component 114 can comprise arbitration component 118 to facilitate updating real-time network conditions and resource availability and allocating network resources based on the conditions and availability, by way of a single component. Components of the disclosed systems and apparatuses can also interact with one or more other components not specifically described herein but known by those of skill in the art, or made known to one of skill in the art by way of the context provided herein.

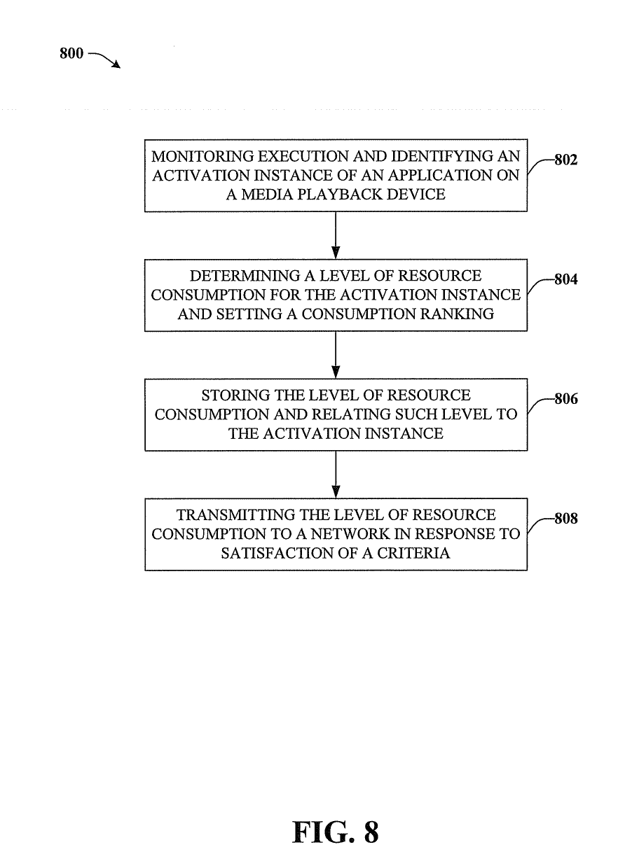

In view of the exemplary diagrams described supra, process methods that may be implemented in accordance with the disclosed subject matter will be better appreciated with reference to the flow chart of FIGS. 8-11. While for purposes of simplicity of explanation, the methods are shown and described as a series of blocks, it is to be understood and appreciated that the disclosed subject matter is not limited by the order of the blocks, as some blocks may occur in different orders and/or concurrently with other blocks from what is depicted and described herein. Moreover, not all illustrated blocks may be required to implement the methods described hereinafter. Additionally, it should be further appreciated that the methods disclosed hereinafter and throughout this specification are capable of being stored on an article of manufacture to facilitate transporting and transferring such methods to an electronic device. The term article of manufacture, as used, is intended to encompass a computer program accessible from any computer-readable device, device in conjunction with a carrier, or storage medium.

FIG. 8 illustrates a flowchart of an example method 800 for facilitating communication services, according to one or more aspects of the subject disclosure. At 802, method 800 can comprise monitoring execution of an application on a media playback device. The monitoring can comprise, for instance, identifying an activation instance of the application. In addition, information pertaining to identification of the activation instance can be recorded. Such information can include temporal associations of the instance of activation, such as time of activation, day of activation, peak or non-peak time of activation, activation on a weekend, a holiday, and so on. The information can also include frequency of activation of various periods, number of other applications executing on the media playback device at time of the instance of activation, or the like, or suitable combinations thereof.

At 804, method 800 can comprise determining a level of network-related resource consumption associated with the execution of the application, or the activation instance of the application. In a particular aspect, the level of network-related resource consumption can be determined within a predetermined or finite range of network resources pertaining to the activation instance or execution. Additionally at 804, method 800 can comprise setting a quantitative or qualitative consumption ranking for the activation instance. The quantitative or qualitative consumption ranking can represent a measure or assessment of network resources consumed by the activation instance.

At 806, method 800 can comprise storing the level of resource consumption and relating the stored level of resource consumption with the activation instance of the application. This provides an association between the particular activation instance and the level of resource consumption that can be referenced in response to the storage. Method 800 can also comprise performing mathematical analysis (e.g., statistical analysis, heuristic analysis, inferential analysis, machine learning, . . . ) on network resource consumption at least in part as a function of activation instances of the client device or a population of client devices (e.g., where storage of pertinent information from one or more other media playback devices is available for such mathematical analysis, in addition to the information stored with respect to the media playback device).

At 808, method 800 can comprise transmitting the level of resource consumption to a network. Such a network can include, for instance, a network that provides content or services related to the application. Examples can include an Internet service provisioning network, a network media provisioning network (e.g., a network providing high definition video services, streaming audio services, audio or audio/video teleconferencing services, and so forth). The transmitting the level of resource consumption can be in response to determining satisfaction of a predetermined criterion related to the transmitting, in at least one aspect of the subject disclosure. Examples of determining satisfaction of a predetermined criterion can include, for instance, identifying expiration of a reporting period, receiving a reporting instruction from the network, achieving a predetermined degree of accuracy in determining the level of resource consumption for the activation instance (or for a set of activation instances of the application, or of multiple applications), identifying the activation instance of the application and determining the level of resource consumption, or the like, or a suitable combination thereof.

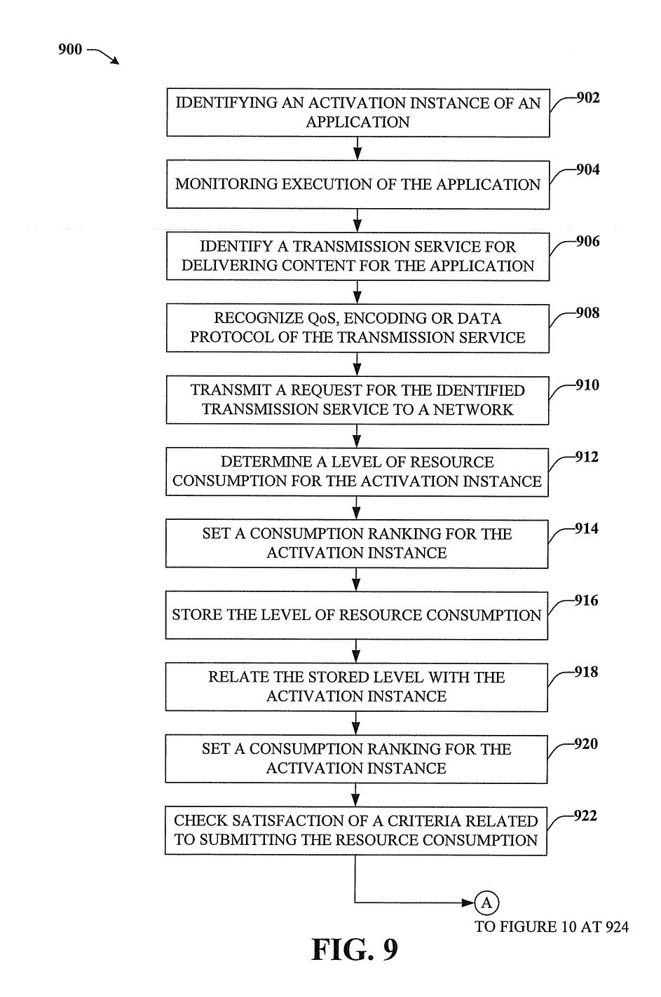

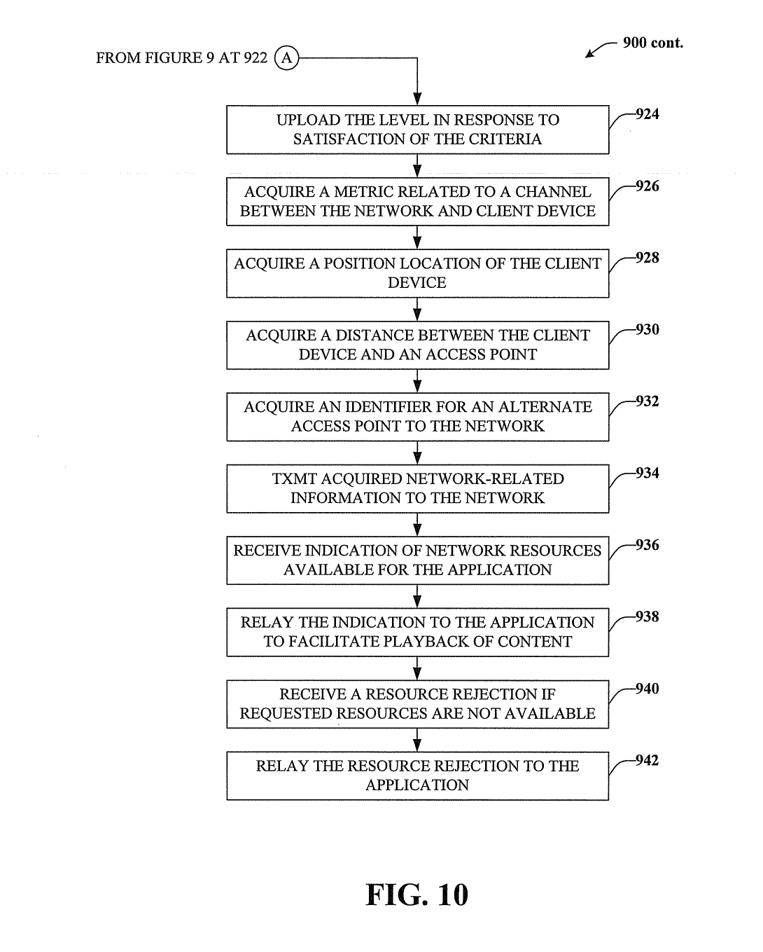

FIGS. 9 and 10 illustrate a flowchart of a sample method 900 according to one or more additional aspects of the subject disclosure. Method 900 can be employed for facilitating acquisition of and reporting of dynamic communication conditions to a network, from client devices served by the network. In at least some aspects, method 900 can facilitate real-time acquisition of dynamic application, service, or network-related resource demands of a population of client devices. Acquisition of such information can be utilized for dynamic provisioning of QoS or network resources associated with support of client-initiated network services, according to one or more particular aspects disclosed herein.

At 902, method 900 can comprise identifying an activation instance of an application operating at a communication device. At 904, method 900 can comprise monitoring execution of the application. At 906, method 900 can comprise identifying a network transmission service associated with delivering or receiving content for the application. The transmission service can comprise a particular network service(s), a class(es) of network service(s), or the like. Some examples could include text-only network services, file download services, streaming media services, teleconferencing services, videoconferencing services, as well as others. At 908, method 900 can comprise recognizing a QoS protocol, a data protocol, an encoding protocol, or other suitable transmission or quality metric or standard for governing operability of the transmission service.

At 910, method 900 can comprise transmitting a request for the identified transmission service to a network. The request for the identified transmission service can be explicit, in some aspects of the subject disclosure, in which the identified transmission service is identified directly in the request. In other aspects, however, the transmission service can be identified implicitly by the request, in which case the request might include a request to service an application, a request for a file, a request for data in a specified or implied protocol, or the like.

At 912, method 900 can comprise determining a level of resource consumption for the activation instance of the application, which can include a period over which the application is executed. At 914, method 900 can comprise setting a consumption ranking for the activation instance. At 916, method 900 can comprise storing the level of resource consumption and, at 918, method 900 can comprise relating the stored level of resource consumption with the activation instance. At 920, method 900 can comprise setting a consumption ranking for the activation instance.

At 922, method 900 can comprise checking satisfaction of a criterion related to submitting the resource consumption. From 922, method 900 continues on FIG. 10, at 924.

Referring now to Figure, method 900 can comprise, at 924, uploading the level of resource consumption in response to satisfaction of the criterion. At 926, method 900 can comprise acquiring a metric related to a channel between the network and client device. At 928, method 900 can comprise acquiring a position location of the client device. Acquiring the position location can be utilized by another application of the communication device (e.g., a GPS equipment, a radio triangulation device, multi-angulation device, . . . ), from a component of a service network (e.g., a base station), a component of an ad-hoc network (e.g., a peer device in a peer-to-peer communication), or the like, or a suitable combination thereof. At 930, method 900 can comprise acquiring a distance between the client device and an access point of the service network. At 932, method 900 can comprise acquiring an identifier for an alternate access point to the service network. At 934, method 900 can comprise transmitting acquired network-related information to the service network, which can include the position location, the distance, or the identifier, a suitable combination thereof, or none of the foregoing in some aspects.

At 936, method 900 can comprise receiving an indication of network resources available for the application. At 938, method 900 can comprise relaying the indication to the application to facilitate playback of content. At 940, method 900 can comprise receiving a resource rejection in response to the requested resources not being available. At 942, method 900 can comprise relaying the resource rejection to the application as a notification of lack of resources.

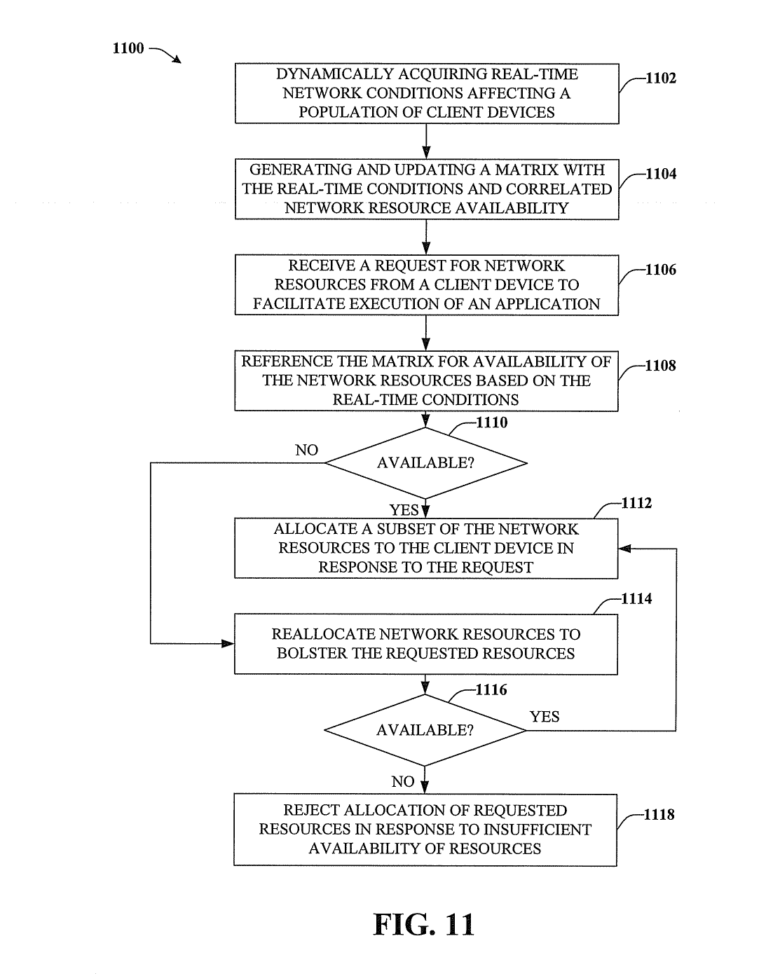

FIG. 11 illustrates a flowchart of an example method for providing network resources in response to dynamic client device demand for applications associated with the network resources, in one or more additional aspects of the subject disclosure. At 1102, method 1100 can comprise dynamically acquiring real-time, or near real-time (e.g., with a delay between occurrence and receipt) network conditions affecting a population of client devices. Acquisition of such information can result from signals transmitted by the client devices themselves, from access points within a network that communicate with the client devices, or from other monitoring or diagnostic equipment of the network.

At 1104, method 1100 can comprise generating and updating a matrix with the real-time conditions, wherein the matrix correlates network conditions with availability of network resources, or support for network services. The matrix can include a plurality of matrices in some aspects of the subject disclosure, in which respective matrices include a subset of correlated information or associated information. For instance, a first matrix could correlate network conditions with predetermined service IDs, a second matrix could correlate respective subsets of network resources configured to support a particular network service(s) or class(es) of service(s) with respective service IDs, and a third matrix could correlate respective service IDs with respective network services supported by the service IDs. Alternatively, a multi-dimensional matrix or database can correlate some or all of the foregoing data and correlations in one or more dimensions of the database.

At 1106, method 1100 can comprise receiving a request for network resources from a client device to facilitate execution of an application at the client device. At 1108, method 1100 can comprise referencing the matrix to determine contemporaneous availability of the network resources based at least in part on the real-time conditions. At 1110, method 1100 can comprise determining whether the request can be satisfied from the contemporaneous availability of the network resources. If so, method 1100 can proceed to 1112; otherwise, method 1100 can proceed to 1114.

At 1112, method 1100 can comprise allocating a subset of the network resources to the client device in response to the request. From 1112, method 1100 can end.

At 1114, method 1100 can comprise reallocating network resources from other subsets of network resources to bolster the requested network services. At 1116, method 1100 can comprise determining a subsequent contemporaneous availability of network resources following the reallocating, and determining whether the request can be satisfied from subsequent contemporaneous availability of network resources. If the request can be satisfied, method 1100 can return to reference number 1112; otherwise, method 1100 can proceed to 1118 and reject allocation of requested network resources in response to insufficient availability of the network resources.

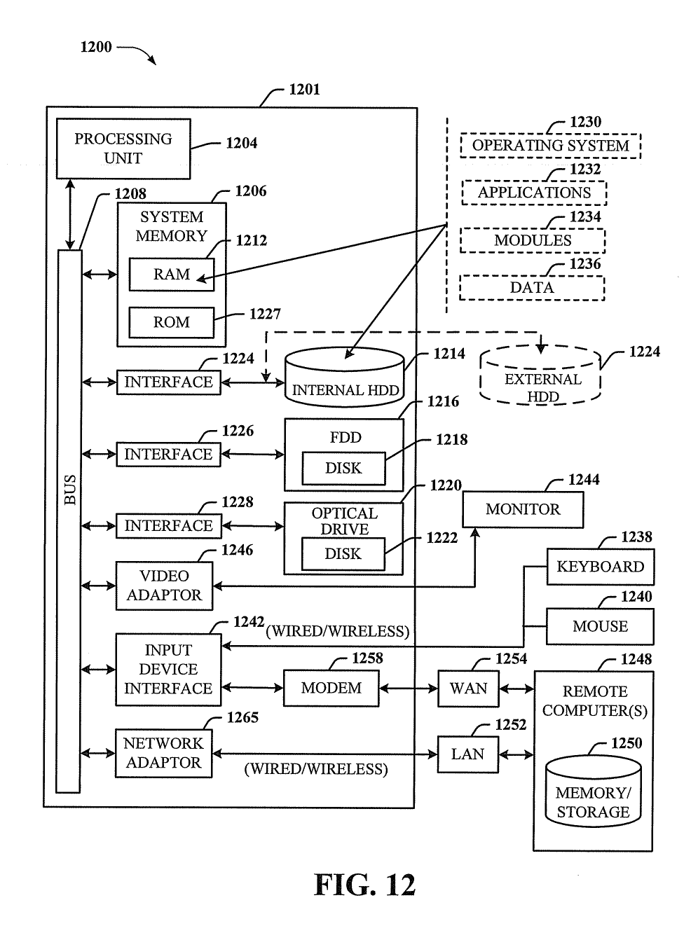

With reference to FIG. 12, an exemplary environment 1200 for implementing various aspects described herein includes a computer 1202, the computer 1202 including a processing unit 1204, a system memory 1206 and a system bus 1208. The system bus 1208 connects system components including, but not limited to, the system memory 1206 to the processing unit 1204. The processing unit 1204 can be any of various commercially available processors. Dual microprocessors and other multi-processor architectures can also be employed as the processing unit 1204.

The system bus 1208 can be any of several types of bus structure that can further interconnect to a memory bus (with or without a memory controller), a peripheral bus, and a local bus using any of a variety of commercially available bus architectures. The system memory 1206 includes read-only memory (ROM) 1210 and random access memory (RAM) 1212. A basic input/output system (BIOS) is stored in a non-volatile memory 1210 such as ROM, EPROM, EEPROM, which BIOS contains the basic routines that help to transfer information between elements within the computer 1202, such as during start-up. The RAM 1212 can also include a high-speed RAM such as static RAM for caching data.

The computer 1202 further includes an internal hard disk drive (HDD) 1214 (e.g., EIDE, SATA), which internal hard disk drive 1214 can also be configured for external use in a suitable chassis (not shown), a magnetic floppy disk drive (FDD) 1216, (e.g., to read from or write to a removable diskette 1218) and an optical disk drive 1220, (e.g., reading a CD-ROM disk 1222 or, to read from or write to other high capacity optical media such as the DVD). The hard disk drive 1214, magnetic disk drive 1216 and optical disk drive 1220 can be connected to the system bus 1208 by a hard disk drive interface 1224, a magnetic disk drive interface 1226 and an optical drive interface 1228, respectively. The interface 1224 for external drive implementations includes at least one or both of Universal Serial Bus (USB) and IEEE 1394 interface technologies. Other external drive connection technologies are within contemplation of the subject innovation.

The drives and their associated computer-readable media provide nonvolatile storage of data, data structures, computer-executable instructions, and so forth. For the computer 1202, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, can also be used in the exemplary operating environment, and further, that any such media can contain computer-executable instructions for performing the methods of the disclosed innovation.

A number of program modules can be stored in the drives and RAM 1212, including an operating system 1230, one or more application programs 1232, other program modules 1234 and program data 1236. All or portions of the operating system, applications, modules, and/or data can also be cached in the RAM 1212. It is to be appreciated that aspects of the subject disclosure can be implemented with various commercially available operating systems or combinations of operating systems.

A user can enter commands and information into the computer 1202 through one or more wired/wireless input devices, e.g., a keyboard 1238 and a pointing device, such as a mouse 1240. Other input devices (not shown) may include a microphone, an IR remote control, a joystick, a game pad, a stylus pen, touch screen, or the like. These and other input devices are often connected to the processing unit 1204 through an input device interface 1242 that is coupled to the system bus 1208, but can be connected by other interfaces, such as a parallel port, an IEEE 1394 serial port, a game port, a USB port, an IR interface, etc.

A monitor 1244 or other type of display device is also connected to the system bus 1208 through an interface, such as a video adapter 1246. In addition to the monitor 1244, a computer typically includes other peripheral output devices (not shown), such as speakers, printers, etc.

The computer 1202 can operate in a networked environment using logical connections by wired and/or wireless communications to one or more remote computers, such as a remote computer(s) 1248. The remote computer(s) 1248 can be a workstation, a server computer, a router, a personal computer, portable computer, microprocessor-based entertainment appliance, a peer device or other common network node, and typically includes many or all of the elements described relative to the computer 1202, although, for purposes of brevity, only a memory/storage device 1250 is illustrated. The logical connections depicted include wired/wireless connectivity to a local area network (LAN) 1252 and/or larger networks, e.g., a wide area network (WAN) 1254. Such LAN and WAN networking environments are commonplace in offices and companies, and facilitate enterprise-wide computer networks, such as intranets, all of which may connect to a global communications network, e.g., the Internet.

When used in a LAN networking environment, the computer 1202 is connected to the local network 1252 through a wired and/or wireless communication network interface or adapter 1256. The adapter 1256 may facilitate wired or wireless communication to the LAN 1252, which may also include a wireless access point disposed thereon for communicating with the wireless adapter 1256.

When used in a WAN networking environment, the computer 1202 can include a modem 1258, or can be connected to a communications server on the WAN 1254, or has other means for establishing communications over the WAN 1254, such as by way of the Internet. The modem 1258, which can be internal or external and a wired or wireless device, is connected to the system bus 1208 through the serial port interface 1242. In a networked environment, program modules depicted relative to the computer 1202, or portions thereof, can be stored in the remote memory/storage device 1250. It will be appreciated that the network connections shown are exemplary and other means of establishing a communications link between the computers can be used.

The computer 1202 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi® and Bluetooth™ wireless technologies. Thus, the communication can be a predefined structure as with a conventional network or simply an ad hoc communication between at least two devices.

Wi-Fi, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11(a, b, g, n, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), or other bands (e.g., 802.11g, 802.11n, . . . ) so the networks can provide real-world performance similar to the basic 10BaseT wired Ethernet networks used in many offices.

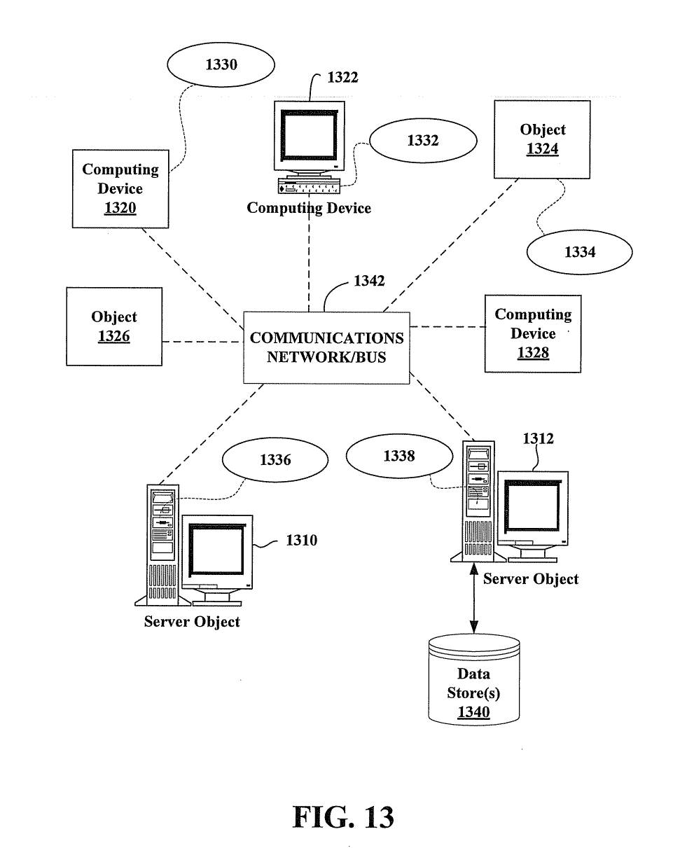

FIG. 13 provides a schematic diagram of an exemplary networked or distributed computing environment. The distributed computing environment comprises server objects 1310, 1312, etc. and computing devices or objects 1320, 1322, 1324, 1326, 1328, etc., which may include programs, methods, data stores, programmable logic, etc., as represented by applications 1330, 1332, 1334, 1336, 1338 and data store(s) 1340. It can be appreciated that server objects 1310, 1312, etc. and computing devices or objects 1320, 1322, 1324, 1326, 1328, etc. may comprise different devices, including dynamic QoS provisioning apparatus 102, 200, 300 or similar entities depicted within the illustrations, or other devices such as a network-enabled display device, network-enabled television, set-top box with network connection and display, satellite receiver and display, mobile phone, personal digital assistant (PDA), audio/video device, MP3 players, personal computer, laptop, etc. It should be further appreciated that data store(s) 1340 can include data stores 116 or 302, database 206, or other similar data stores disclosed herein.

Each server object 1310, 1312, etc. and computing devices or objects 1320, 1322, 1324, 1326, 1328, etc. can communicate with one or more other server objects 1310, 1312, etc. and computing devices or objects 1320, 1322, 1324, 1326, 1328, etc. by way of the communications network 1342, either directly or indirectly. Even though illustrated as a single element in FIG. 13, communications network 1342 may comprise other computing objects and computing devices that provide services to the system of FIG. 13, or may represent multiple interconnected networks, which are not shown. Each server object 1310, 1312, etc. or computing device or object 1320, 1322, 1324, 1326, 1328, etc. can also contain an application, such as applications 1330, 1332, 1334, 1336, 1338, that might make use of an API, or other object, software, firmware and/or hardware, suitable for communication with or implementation of the techniques for search augmented menu and configuration functions provided in accordance with various embodiments of the subject disclosure.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for exemplary communications made incident to the systems for search augmented menu and configuration functions as described in various embodiments.

Thus, a host of network topologies and network infrastructures, such as client/server, peer-to-peer, or hybrid architectures, can be utilized. One or more of these network topologies can be employed by account authorization apparatus 102, 402, 508 or selective provisioning apparatus 202, 302, 502 for communicating with a network. The “client” is a member of a class or group that uses the services of another class or group to which it is not related. A client can be a process, e.g., roughly a set of instructions or tasks, that requests a service provided by another program or process. The client process utilizes the requested service, in some cases without having to “know” any working details about the other program or the service itself. A client device can be a computing device or object 1320, 1322, 1324, 1326, 1328 upon which a client process operates or is executed, in one or more disclosed aspects.

In a client/server architecture, particularly a networked system, a client is usually a computer that accesses shared network resources provided by another computer, e.g., a server. In the illustration of FIG. 13, as a non-limiting example, computing devices or objects 1320, 1322, 1324, 1326, 1328, etc. can be thought of as clients and server objects 1310, 1312, etc. can be thought of as servers where server objects 1310, 1312, etc., acting as servers provide data services, such as receiving data from client computing devices or objects 1320, 1322, 1324, 1326, 1328, etc., storing of data, processing of data, transmitting data to client computing devices or objects 1320, 1322, 1324, 1326, 1328, etc., although any computer can be considered a client, a server, or both, depending on the circumstances.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to the techniques described herein can be provided standalone, or distributed across multiple computing devices or objects.

In a network environment in which the communications network 1342 or bus is the Internet, for example, the server objects 1310, 1312, etc. can be Web servers with which other computing devices or objects 1320, 1322, 1324, 1326, 1328, etc. communicate via any of a number of known protocols, such as the hypertext transfer protocol (HTTP). Server objects 1310, 1312, etc. acting as servers may also serve as clients, e.g., computing devices or objects 1320, 1322, 1324, 1326, 1328, etc., as may be characteristic of a distributed computing environment.

The subject matter described herein can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, computer-readable carrier, or computer-readable media. For example, computer-readable media can include, but are not limited to, a magnetic storage device, e.g., hard disk; floppy disk; magnetic strip(s); an optical disk (e.g., compact disk (CD), a digital video disc (DVD), a Blu-ray Disc™ (BD)); a smart card; a flash memory device (e.g., card, stick, key drive); and/or a virtual device that emulates a storage device and/or any of the above computer-readable media.

The word “exemplary” where used herein means serving as an example, instance, or illustration. For the avoidance of doubt, the subject matter disclosed herein is not limited by such examples. In addition, any aspect, embodiment or design described herein as “exemplary”, “demonstrative”, “illustrative”, or the like, is not necessarily to be construed as preferred or advantageous over other aspects or designs, nor is it meant to preclude equivalent exemplary structures and techniques known to those of ordinary skill in the art.

As used herein, the term “infer” or “inference” refers generally to the process of reasoning about, or inferring states of, the system, environment, user, and/or intent from a set of observations as captured via events and/or data. Captured data and events can include user data, device data, environment data, data from sensors, sensor data, application data, implicit data, explicit data, etc. Inference can be employed to identify a specific context or action, or can generate a probability distribution over states of interest based on a consideration of data and events, for example.

Inference can also refer to techniques employed for composing higher-level events from a set of events and/or data. Such inference results in the construction of new events or actions from a set of observed events and/or stored event data, whether the events are correlated in close temporal proximity, and whether the events and data come from one or several event and data sources. Various classification schemes and/or systems (e.g., support vector machines, neural networks, expert systems, Bayesian belief networks, fuzzy logic, and data fusion engines) can be employed in connection with performing automatic and/or inferred action in connection with the disclosed subject matter.

Furthermore, to the extent that the terms “includes,” “has,” “contains,” and other similar words are used in either the detailed description or the appended claims, such terms are intended to be inclusive—in a manner similar to the term “comprising” as an open transition word—without precluding any additional or other elements. Moreover, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What is claimed is:

1. A method for facilitating electronic communication services, comprising:
monitoring, by a system including a processor, execution of an application on a media playback device including identifying an activation instance of the application;
determining a level of resource consumption within a predetermined and finite range of network resources for the activation instance of the application, and setting a quantitative or qualitative consumption ranking for the activation instance;
storing the level of resource consumption and relating the stored level of resource consumption with the activation instance of the application; and
transmitting the level of resource consumption to a network that provides content or services related to the application, in response to determining satisfaction of a predetermined criterion related to the transmitting.

2. The method of claim 1, further comprising identifying a transmission service requested by the application in response to execution of the application.

3. The method of claim 2, wherein identifying the transmission service further comprises recognizing an elevated quality of service (QoS) requested by the application.

4. The method of claim 2, wherein identifying the transmission service further comprises recognizing an encoding protocol requested by the application.

5. The method of claim 2, wherein identifying the transmission service further comprises recognizing a streaming data protocol requested by the application.

6. The method of claim 2, further comprising transmitting a request for the identified transmission service to the network in conjunction with transmitting the level of resource consumption.

7. The method of claim 1, wherein determining the satisfaction of the predetermined criterion further comprises identifying expiration of a reporting period.

8. The method of claim 1, wherein determining the satisfaction of the predetermined criterion further comprises receiving a reporting instruction from the network.

9. The method of claim 1, wherein determining the satisfaction of the predetermined criterion further comprises achieving a predetermined degree of accuracy in determining the level of resource consumption for the activation instance.

10. The method of claim 1, wherein determining the satisfaction of the predetermined criterion is in response to identifying the activation instance of the application and in response to determining the level of resource consumption.

11. The method of claim 1, further comprising acquiring a metric related to a communication channel between the network and the media playback device, and submitting the metric to the network.

12. The method of claim 11, wherein acquiring the metric further comprises measuring radio condition of a wireless communication channel between the network and the media playback device, and submitting the radio condition to the network.

13. The method of claim 1, further comprising acquiring a position location of the media playback device and submitting the position location to the network.

14. The method of claim 1, further comprising acquiring a distance between the media playback device and an access node of the network, and submitting the distance to the network.

15. The method of claim 1, further comprising acquiring an identifier for an alternate access point to the network, and submitting the identifier to the network.

16. The method of claim 1, further comprising receiving a message indicating a level of network resources for dynamic allocation to the media playback device in response to transmitting the level of resource consumption.

17. The method of claim 16, further comprising relaying the level of network resources to the application or to an operating system of the media playback device for facilitating content playback consistent with the level of network resources.

18. The method of claim 1, further comprising receiving a message indicating unavailability of a requested level of network resources in response to transmitting the level of resource consumption.

19. The method of claim 18, further comprising relaying the unavailability of the requested level of network resources to the application or to an operating system of the media playback device for facilitating content playback consistent with a lower than requested level of network resources.

20. A system for providing network resources, comprising:
a processor that facilitates operation of computer-executable components, comprising:
a communication component configured to dynamically acquire respective communication-related conditions for a dynamic population of client devices, the communication-related conditions including dynamic network resource demands of the client devices;
a data management component configured for updating a matrix accessible from a data store with the dynamically-acquired communication-related conditions, wherein the matrix relates a set of conditions, which include the communication-related conditions, affecting one or more of the client devices with a set of network services, respective ones of the set of network services are matched to respective subsets of a set of network resources, and the subsets are configured to support operation of matching ones of the set of network services; and
an arbitration component configured for identifying a subset of network resources that matches a network service activated by one of the client devices and for allocating the subset of network resources to the one of the client devices in response to satisfaction of a qualification criterion.

21. The system of claim 20, wherein the communication component acquires real-time signaling from the one of the client devices, extracts data related to communication-related conditions or network resource demands pertaining to the one of the client devices from the real-time signaling, and provides the extracted data to the data management component for updating the matrix.

22. The system of claim 20, wherein:
the communication component acquires a quantitative value for one of the communication-related conditions; and
the data management component updates the matrix to reflect the quantitative value.

23. The system of claim 22, wherein the quantitative value is a result of a measurement corresponding to one of the set of conditions.

24. The system of claim 23, wherein the data management component updates a segment of the matrix associated with the one of the set of conditions to reflect the quantitative value.

25. The system of claim 22, wherein the data management component converts the quantitative value into a qualitative assessment of a corresponding one of the set of conditions, and updates a segment of the matrix that is associated with the one of the set of conditions with the qualitative assessment, to have the matrix reflect the quantitative value.

26. The system of claim 20, wherein the computer-executable components further comprise a resource accounting component configured to monitor quantitative or qualitative valuations of the set of conditions stored with the matrix and determine current availability of respective subsets of the set of network resources.

27. The system of claim 26, wherein the arbitration component is further configured to reject allocation of the subset of the set of network resources to the one of the client devices in response to the resource accounting component determining that the subset is not available to support the network service.

28. The system of claim 26, wherein the arbitration component is further configured to approve allocation of the subset of the set of network resources to the one of the client devices in response to the resource accounting component determining that the subset is available to support the network resource.

29. The system of claim 26, wherein the resource accounting component is further configured to analyze the set of network resources and determine a degree of utilization of respective subsets of the set of network resources.

30. The system of claim 29, wherein the computer-executable components further comprise a resource balancing component configured to re-allocate a portion of one of the set of network resources, in response to the resource accounting component determining the one of the set of network resources to be under-utilized, and increase the current availability of the subset of the set of network resources.

31. The system of claim 30, wherein the arbitration component is further configured to approve allocation of the subset of the set of network resources in response to:
the resource accounting component determining that the current availability of the subset of the set of network resources is insufficient to support the network service;
the balancing component re-allocating the portion of the one of the set of network resources to improve the current availability of the subset of the set of network resources; and
the resource accounting component subsequently determining that the current availability has improved sufficient to support the network service.

32. The system of claim 29, wherein the computer-executable components further comprise a quality of service (QoS) provisioning component configured to selectively increase or decrease a level of QoS, and a corresponding amount of an associated one of the subsets of the set of network resources, for supporting one of the network services in response to the current availability satisfying or failing to satisfy a condition pertaining to network resource consumption.

33. The system of claim 20, wherein the set of network services comprises a text service, a rich content web service, a phone conferencing service, a video conferencing service or a streaming television service.

34. The system of claim 20, wherein the qualification criterion relates to current availability of the subset of the set of network resources.

35. The system of claim 34, wherein the qualification criterion further relates to a degree of quality of service (QoS) associated with the network service and whether the current availability supports the degree of QoS.

36. The system of claim 34, wherein the qualification criterion further relates to a degree of QoS provided with a service agreement associated with the one of the client devices and whether the current availability supports the degree of QoS.

37. A system for network communication, comprising:
means for dynamically acquiring real-time network conditions affecting a population of mobile communication devices;
means for updating a matrix with the real-time network conditions and with availability of network resources that are correlated by the matrix to the real-time network conditions;
means for allocating a subset of the network resources to one of the mobile communication devices in response to activation of a network service related to the subset of the network resources at the one of the mobile communication devices, wherein a quantity of the subset of the network resources is at least in part defined by a level of quality of service (QoS) associated with the network service; and
means for adjusting the level of QoS associated with the network service at least in part in response to changes in the availability of network resources.

38. The system of claim 37, further comprising means for parsing signals transmitted by the population of mobile communication devices and extracting data from the signals related to the real-time network conditions.

39. The system of claim 37, further comprising means for exempting a subset of the mobile communication devices from a decrease beyond a baseline level of QoS for network services consumed by the subset of the mobile communication devices.

40. The system of claim 37, further comprising means for correlating availability of network resources with geographic locations of a mobile network, wherein the means for adjusting the level of QoS is configured to adjust the level of QoS for subsets of the geographic locations that are associated with elevated consumption of network resources.

41. The system of claim 37, further comprising means for updating a billing rate associated with the network service at least in part in response to adjusting the level of QoS.

42. The system of claim 37, further comprising means for billing the network service that charges an account of the one of the mobile communication devices a rate commensurate with actual resources consumed by the network service, or actual QoS delivered in support of the network service.

43. A tangible computer readable storage medium storing computer-executable instructions that, in response to execution, cause a computing system including a processor to perform operations for providing network media content, comprising:
dynamically acquiring data that is representative of a set of dynamic network conditions affecting a population of client devices;
generating and updating a matrix with the dynamically acquired data, wherein the matrix correlates the dynamic network conditions with subsets of network resources;
receive a request for network resources from a client device;
reference the matrix to determine availability of the network resources; and
allocating one of the subsets of network resources in response to determining availability of the one of the subsets of network resources, and rejecting the request in response to determining insufficient availability of the one of the subsets of network resources.

44. The tangible computer readable storage medium of claim 43, wherein the operations further comprise correlating the subsets of network resources with respective network services supported by the network.

45. The tangible computer readable storage medium of claim 43, wherein the operations further comprise re-organizing the subsets of network resources to apportion an available resource to the one of the subsets of network resources in response to determining insufficient availability of the one of the subsets of network resources, thereby generating a modified subset of the network resources, and allocating the modified subset of the network resources in response to the request.
